(19) United States
(12) Patent Application Publication
(10) Pub. No.: US 2005/0108389 A1
(43) Pub. Date: May 19, 2005

(54) Network endpoint health check

(75) Inventors: Christopher W. Kempin, Holly Springs, NC (US); Robert L. Orr, Raleigh, NC (US); Rosalind Toy Allen Radcliffe, Durham, NC (US)

Correspondence Address: Gerald R. Woods;IBM Corporation, T81/503, PO Box 12195, Research Triangle Park, NC, 27709, US

(73) Assignee: International Business Machines Corporation, Armonk, NY (US)

(21) Appl. No.: 10/712,677

(22) Filed: Nov. 13, 2003

(51) Int. Cl. G06F 15/173

(52) U.S. Cl. 709/224

(57) ABSTRACT

In a system and method for monitoring the integrity of a plurality of endpoint devices in a network, each endpoint device is in communication with a gateway device and transmits a periodic message to this gateway device. When the gateway device fails to receive a periodic message from an endpoint, the gateway device marks the endpoint as in trouble. The next time the gateway device fails to receive a periodic message from the same endpoint, the gateway device marks the endpoint as removed. The gateway is in communication with a central server and sends status update messages to this central server.

### BACKGROUND OF THE INVENTION

1. Field of the Invention

The present invention generally relates to computer networks and, more specifically, to monitoring of computers on a distributed network.

2. Description of the Related Art

In a distributed computing environment, proper operation is dependent upon the continued operation of numerous agent “engines” and the integrity of their communications channels to a centralized control point. The challenge is increased as there is a requirement that failures in any of these distributed engines must be reported on a near real time basis. Several solutions have been attempted to monitor the remote engines but they are generally inadequate.

One such attempt is an “out-of-band” monitoring system that uses a separate communication channel for monitoring. An “out-of-band” monitoring solution is inadequate, because it does not test communication channels between distributed components. An adequate solution must determine the ability of an engine to use the existing communications channels to communicate with a control infrastructure, and such solution might be able to determine that the engine is active, but not provide a systemic evaluation.

Another attempt to monitor the remote engines is to use a central polling mechanism. However, the centralized polling mechanism is also inadequate because it stresses the control infrastructure and prevents the infrastructure from carrying out necessary functions.

A further attempt to monitor the remote engines is to use “health checking” with a centralized server monitoring the remote engines with periodic interaction through the existing communication channels. However, this solution is also inadequate because it has scalability problems when tracking large numbers of client engines.

### SUMMARY OF THE INVENTION

The invention is a system and method that insure the proper monitoring of a plurality of endpoints and communication channels used for communications between the endpoints and a gateway device. The system includes an endpoint with a monitoring application for monitoring the integrity of the endpoint, a server with a centralized database that lists the status of the endpoint, and a gateway device in communication with the server and with the endpoint. The monitoring application at a predetermined time sends a periodic signal through a communication channel to the gateway device indicating the integrity of the endpoint. The gateway device includes a monitored list that lists the status of the endpoint. The gateway device sends a state change message to the server if the gateway device fails to receive a periodic signal from the endpoint and if the status of the endpoint is either in a Sane state, which indicates the endpoint is functioning properly, or a Trouble state, which indicates the endpoint has failed once. The gateway device does not send any state change message to the server upon a failure to receive the periodic signal from the endpoint if the status of the endpoint is in a Removed state, which indicates the endpoint has been removed from the monitored list.

The invention is also a method for monitoring the integrity of a endpoint and a data channel between the endpoint and a gateway device. The method includes determining the health of an endpoint. If the endpoint is in a Healthy state, which indicates the endpoint is functioning properly, a periodic signal is sent at a predetermined time through the data channel to the gateway device associated with the endpoint. If the gateway device fails to receive a periodic signal from the endpoint and if the status of the endpoint in a monitored list in the gateway device is the Healthy state, the status of the endpoint in the monitored list is set to a Trouble state, which indicates the endpoint has failed once, and a state change signal is sent to a server indicating the status of the endpoint has been set to the Trouble state. If the gateway device fails to receive a periodic signal from the endpoint and if the status of the endpoint in a monitored list in the gateway device is the Trouble state, the status of the endpoint in the monitored list is set to a Removed state, which indicates the endpoint has been removed from the monitored list, and a state change signal is sent to the server indicating the status of the endpoint has been set to the Removed state.

Other advantages and features of the present invention will become apparent after review of the hereinafter set forth Brief Description of the Drawings, Detailed Description of the Invention, and the claims.

### BRIEF DESCRIPTION OF THE DRAWINGS

FIG. 1 is a system architecture according to the invention.

FIG. 2 is a monitored table employed in a gateway device.

FIG. 3 is an endpoint table in a central server.

FIG. 4 is a flow chart for a gateway device.

FIG. 5 is a flow chart for a central server.

### DETAILED DESCRIPTION OF THE INVENTION

In this description, the terms “monitored list” and “endpoint table” are used interchangeably, and like numerals refer to like elements throughout the several views. The articles “a” and “the” includes plural references, unless otherwise specified in the description.

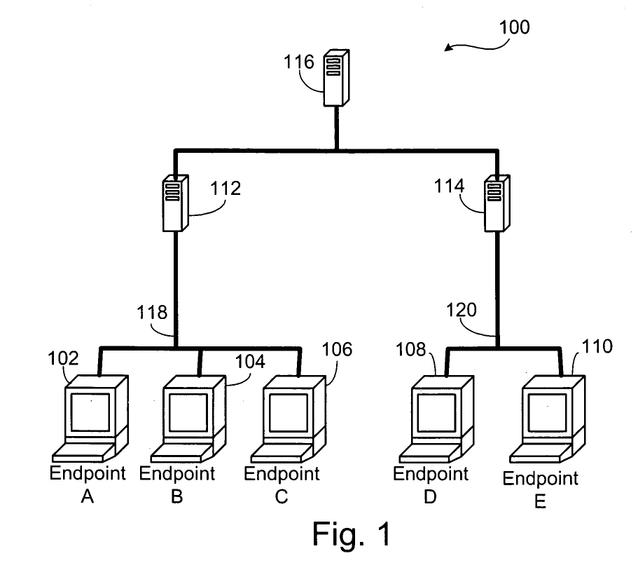

FIG. 1 illustrates a distributed computing network 100. A plurality of endpoints 102-110 are connected via communication channels 118, 120 to multiple gateway devices 112, 114, and these gate devices 112, 114 are connected to a central server 116. Each endpoint 102-110 is a computing device that provides computing resources to a network and is monitored by a gateway device 112, 114. The computing device 102-110 has a monitoring application that determines the health of the endpoint by periodically diagnosing the endpoint 102-110 and sending a health signal to its associated gateway device 112, 114. The endpoint 102-110 is “healthy” or stable if the endpoint 102-110 is performing functions in an expected manner, and the health signal is a signal indicating that the endpoint 102-110 is functioning properly. If the computing device 102-110 is stable, healthy, or otherwise without any problem, the monitoring application sends the health signal to the gateway device 112, 114 through a communication channel that links the gateway device 112, 114 to the endpoint 102-110. The health signal may be a regular data message and the transmission of this message in an in-band fashion, i.e., the transmission is not through a special control channel. By transmitting the health signal in the in-band fashion through a data channel connecting the computing device 102-110 to the gateway machine 112, 114, the data channel is also tested.

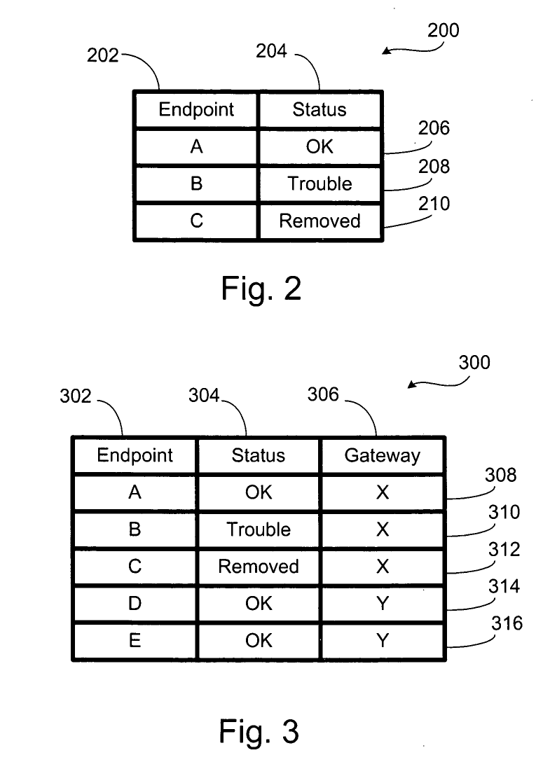

Each gateway device 112, 114 has an endpoint table 200, shown in FIG. 2, listing all the endpoints 202 connected to and monitored by the gateway device 112 and their respective statuses 204. Each entry in the endpoint table 200 corresponds to an endpoint. The status of an endpoint may be, for example, “Healthy,” “Trouble,” or “Removed.” An endpoint is listed as Healthy until it fails to send a first periodic message to the gateway device 112. When the gateway device 112 fails to receive a periodic message from an endpoint for the first time, the gateway device 112 changes the status of this endpoint to Trouble. When the gateway device 112 fails to receive another periodic message from the same endpoint, the gateway device 112 changes the status for this endpoint to Removed.

The failure to receive a second periodic message, i.e., the second failure, occurs after the first failure to receive a periodic message. The endpoint may interpret a failure as the second failure if the failure occurs within a specific number of periodic messages after the first failure or within a specific time after the first failure, or if the failure is a failure that follows the first failure.

When there is a status change in an endpoint 102-110, the gateway device 112, 114 sends a state change message to the central server 116. FIG. 3 is a health table 300 (a centralized database) of all endpoints maintained by the central server 116. The health table 300 provides the status of endpoints. The central server 116 uses this health table 300 to track and monitor all endpoints in the system. The health table 300 lists all the endpoints 302, their status 304, and their associated gateway devices 306. Each endpoint has an entry in the health table 300. When the central server 116 receives a state change message for a specific endpoint from a gateway device, the central server 116 changes the status of that endpoint. The status changes to Trouble when a trouble message is received and to Removed when a removed message is received.

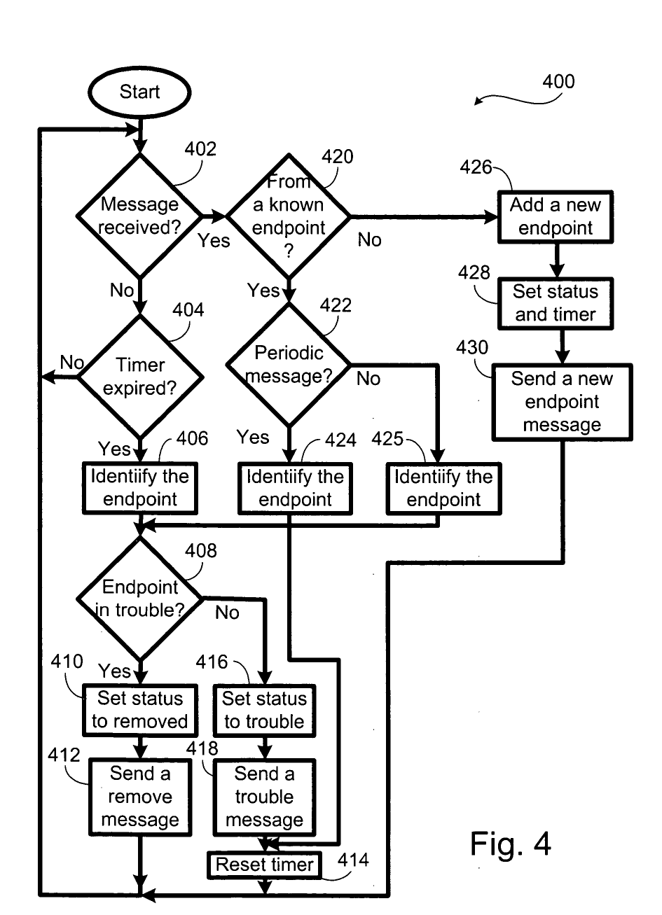

FIG. 4 is a flow chart 400 for a gateway device monitoring the endpoints. The gateway device checks whether a message has been received, step 402. If there is no incoming messages, the gateway device 112, 114 checks whether a timer has expired, step 404. If the timer has not expired, the gateway device 112, 114 loops back to check for more messages, step 402. There is one timer associated with each endpoint and each endpoint is expected to send a periodic health message to the gateway device before its timer expires.

If a timer has expired, the gateway device identifies the endpoint associated with the expired timer, step 406, and checks whether the endpoint is in Trouble state, step 408. The gateway device may learn whether the endpoint is in Trouble state by checking its endpoint table 200. If the status of the endpoint is not Trouble, the gateway device sets the status to Trouble, step 416, and sends a trouble message, step 418, to the central server 116. After sending the message to the central server, the gateway device resets the timer, step 414.

If the status of the endpoint is Trouble, the gateway device changes the status to Removed, step 410, and sends a removed message to the central server, step 412. When an endpoint's status is Removed, the gateway device will no longer send any additional messages regarding this endpoint to the central server. This prevents unnecessary messages from clogging the communication channels between the gateway device and the central server 116. Optionally, the gateway device can remove the endpoint from its monitored list and/or the endpoint list 200 after changing its status to Removed.

If the gateway device has received a message, it checks whether it is from one of the endpoints in its endpoint table 200, step 420. If the message is from an endpoint in the endpoint table, the gateway device checks whether it is a periodic message or a “heartbeat” message, step 422. The periodic message essentially is a health message indicating the endpoint is functioning properly. If the message is a periodic message, the gateway device identifies the endpoint, step 424, and resets the timer associated with the endpoint, step 414.

If the message is not a periodic message, the gateway device identifies the endpoint, step 425, and then determines whether the endpoint is in trouble, step 408, by checking the endpoint table 200 and proceeds with steps decribed above.

If the message is not from an endpoint listed in the endpoint table 200, the gateway device adds an entry to the endpoint table 200 for this new endpoint. The ability to receive messages from new endpoints is helpful for self-configuration of the gateway device. After the new endpoint is added, the gateway device sets the status to Healthy and resets the corresponding timer, step 428. The gateway device also sends a new endpoint (config) message to the central server 116 so that the new endpoint can be added to the central server's database.

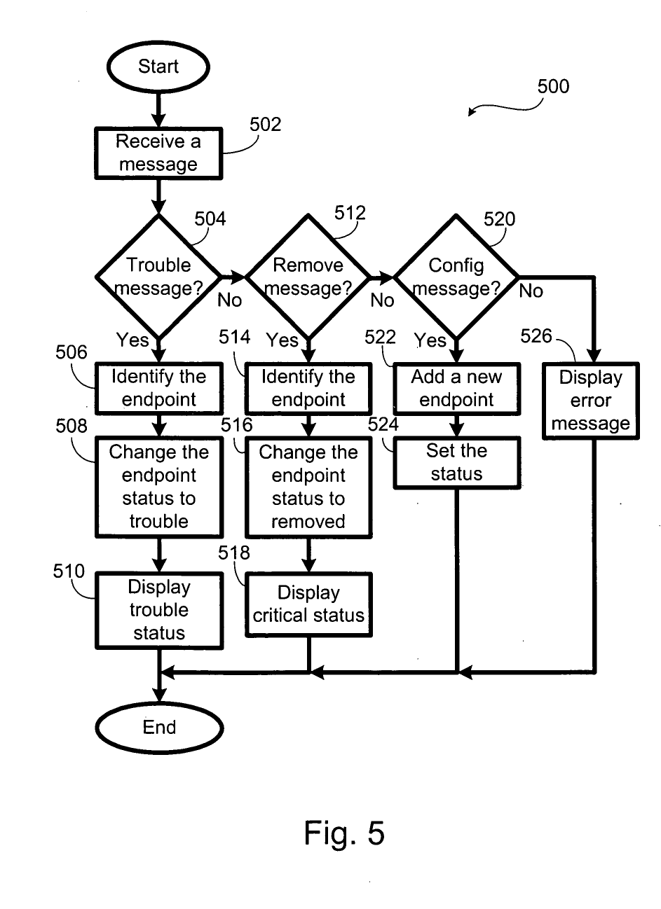

FIG. 5 is flow chart 500 for a central server 116. When the central server 116 receives a message, step 502, it checks the type of the message, step 504. If it is a trouble message, the central server 116 identifies the endpoint listed in the message, step 506, and changes the status of the associated endpoint to Trouble, step 508. The central server 116 may additionally display the Trouble status of the associated endpoint, step 510, so human operators may take appropriate actions.

If the message is a remove message, the central server 116 identifies the endpoint listed in the message, step 514, and changes the status of the associated endpoint to Removed, step 516. The central server 116 may additionally display the Removed status of the associated endpoint, step 518, so human operators may take appropriate actions.

If the message is a configuration message, the central server 116 adds an entry for the new endpoint into the health table 300, step 522, and sets its status to Healthy, step 524. If the message type is unknown, the central server 116 displays an error message, step 526.

A system according to the invention is scalable. New endpoints can be added easily to the system and the system automatically updates its information to reflect the current configuration. If a new endpoint is added, the gateway device adds a new entry in its endpoint table 200. If an endpoint encounters a problem and fails to send a health signal to the gateway device, the gateway device automatically changes the status of this endpoint to Trouble and informs the central server about the possible problem with this endpoint.

In the present invention, health and other type of messages, such as trouble message and remove message, do not require dedicated communication channels. The messages are transmitted normally as any other data between an endpoint and the gateway device. In this manner, the integrity of the communication channel is also tested. If a gateway device is no longer receiving health messages from all of the endpoints listed in its endpoint table, it is a strong indication that there may be a substantial problem with the communication channels.

While the invention has been particularly shown and described with reference to a preferred embodiment thereof, it will be understood by those skilled in the art that various changes in form and detail maybe made without departing from the spirit and scope of the present invention as set for the in the following claims. Furthermore, although elements of the invention may be described or claimed in the singular, the plural is contemplated unless limitation to the singular is explicitly stated.

1. A system for monitoring the integrity of a plurality of endpoints and a communication channel between the plurality of endpoints and a gateway device, comprising:
an endpoint having a monitoring application for monitoring the integrity of the endpoint, the monitoring application at a predetermined time sending a periodic signal through a communication channel to the gateway device indicating the integrity of the endpoint;
a server having a centralized database listing the status of the endpoint; and
a gateway device in communication with the server and with the endpoint, the gateway device including a monitored list listing the status of the endpoint in communication with the gateway device, the gateway device being capable of selectively sending a state change message to the server if the gateway device fails to receive a periodic signal from the endpoint and if the status of the endpoint is either in a Healthy state, which indicates the endpoint is functioning properly, or a Trouble state, which indicates the endpoint has failed once, the gateway device further being capable of not sending the state change message to the server upon a failure to receive the periodic signal from the endpoint if the status of the endpoint is in a Removed state, which indicates the endpoint has been removed from the monitored list.

2. The system of claim 1, wherein the periodic signal is sent through a data channel connecting the endpoint and the gateway.

3. The system of claim 1, wherein the status of the endpoint is set to the Trouble state when the gateway device fails to receive the periodic signal from the endpoint and the status of the endpoint is in the Healthy state.

4. The system of claim 1, wherein the status of the endpoint is set to the Removed state when the gateway device fails to receive the periodic signal from the endpoint and the status of the endpoint is in the Trouble state.

5. The system of claim 1, wherein the centralized database has a plurality of entries, each entry being associated with one endpoint, the status of the endpoint, and the gateway device associated with the endpoint.

6. The system of claim 1 further comprising a timer, wherein the timer is associated with the endpoint.

7. A method for monitoring the integrity of a endpoint and a data channel between the endpoint and a gateway device, comprising the steps of:
determining the health of an endpoint;
if the endpoint is in a Healthy state, which indicates the endpoint is functioning properly, sending a periodic signal at a predetermined time through the data channel to the gateway device associated with the endpoint;
if the gateway device fails to receive a periodic signal from the endpoint and if the status of the endpoint in a monitored list in the gateway device is the Healthy state, setting the status of the endpoint in the monitored list to a Trouble state, which indicates the endpoint has failed once, and sending a state change signal to a server indicating the status of the endpoint has been set to the Trouble state; and
if the gateway device fails to receive a periodic signal from the endpoint and if the status of the endpoint in a monitored list in the gateway device is the Trouble state, setting the status of the endpoint in the monitored list to a Removed state, which indicates the endpoint has been removed from the monitored list, and sending a state change signal to the server indicating the status of the endpoint has been set to the Removed state.

8. The method of claim 7, further comprising the steps of:
determining if a timer associated with the endpoint has expired;
if the timer has expired, determining the status of the endpoint associated with the timer;
if the status of the endpoint is the Healthy state, setting the status of the endpoint to the Trouble state;
if the status of the endpoint is the Trouble state, setting the status of the endpoint to the Removed state; and
resetting the timer.

9. The method of claim 7, further comprising the steps of:
receiving a configuration signal from the endpoint;
determining if the endpoint is listed in the monitored list; and
if the endpoint is not listed in the monitored list, adding the endpoint to the monitored list and transmitting a configuration signal to the server.

10. A method for monitoring the integrity of a endpoint and a data channel between the endpoint and a gateway device, comprising the steps of:
determining the status of an endpoint in a monitored list in the gate device;
if the status of the endpoint is either a Healthy state, which indicates the endpoint is functioning properly, or a Trouble state, which indicates the endpoint has failed once, setting a timer for an endpoint listed in a monitored list in the gateway device;
if the timer expires and the status of the endpoint in the monitored list is in the Healthy state, setting the status of the endpoint to the Trouble state and sending a first state change message to a server;
if the timer expires and the status of the endpoint in the monitored list is in the Trouble state, setting the status of the endpoint to a Removed state, which indicates the endpoint has been removed from the monitored list, and sending a second state change message to the server; and
resetting the timer if a periodic message is received from the endpoint.

11. A system for monitoring the integrity of a plurality of endpoints and a communication channel between the plurality of endpoints and a gateway device, comprising:
an endpoint means having a monitoring means for monitoring the integrity of the endpoint means, the monitoring means at a predetermined time sending a periodic signal through a communication means to the gateway device indicating the integrity of the endpoint means;
a server means having a centralized database means listing the status of the endpoint means; and
a gateway means in communication with the server means and with the endpoint means, the gateway means including a monitored list listing the status of the endpoint means in communication with the gateway means, the gateway means being capabale of selectively sending a state change message to the server means if the gateway means fails to receive a periodic signal from the endpoint means ad if the status of the endpoint means is either a Healthy state, which indicates the endpoint is functioning properly, or a Trouble state, which indicates the endpoint has failed once, the gateway means further capable of not sending the state change message to the server means upon a failure to receive the periodic signal from the endpoint means if the status of the endpoint means in the monitored list is a Removed state, which indicates the endpoint has been removed from the monitored list.
